(19) United States
(12) Patent Application Publication
(10) Pub. No.: US 2024/0219269 A1
(43) Pub. Date: Jul. 4, 2024

(54) BIOLOGICAL SAMPLE PREPROCESSING DEVICE

(71) Applicant: Industrial Technology Research Institute, Hsinchu (TW)

(72) Inventors: Tseng-Huang LIU, Kaohsiung City (TW); Nien-Jen CHOU, Hsinchu City (TW); Yuh-Tyng TSAI, Taipei City (TW); Yi-Yun YUAN, Hsinchu City (TW); Chia-Ying TANG, Hsinchu City (TW)

(73) Assignee: Industrial Technology Research Institute, Hsinchu (TW)

(21) Appl. No.: 18/091,952

(22) Filed: Dec. 30, 2022

(51) Int. Cl. G01N 1/14

(52) U.S. Cl. CPC G01N 1/14

(57) ABSTRACT

A biological sample pretreatment device includes a base body and a moveable part. The base body is formed with an elongated accommodation space configured to accommodate a sampling tube and a reaction tube aligned with each other. The moveable part moveably connects to the base body for ejecting the reaction tube from the base body.

### TECHNICAL FIELD

The present invention relates to a biological sample pretreatment device, and, in particular, to a biological sample pretreatment device that can reduce the risk of infection and contamination.

### BACKGROUND

Most clinical samples of general infectious diseases require the use of a sampling swab to obtain nasopharyngeal or oropharyngeal sample, put the sample into a sample tube to perform virus deactivation or rapid extraction of nucleic acid, and then drop the sample into a rapid screening test strip or a PCR reaction tube for reaction.

However, the above process relies on manual operations, which presents a risk of infection or contamination.

In view of this, how to provide a biological sample pretreatment device to prevent operators from directly contacting the sampling tubes and reaction tubes with their hands to reduce the risks of infection and contamination has become one of the important challenges for researchers in this field.

### SUMMARY

In view of the well-known problems detailed above, an embodiment of the present invention provides a biological sample pretreatment device that includes a base body and a moveable part. The base body formed with an elongated accommodation space and an arc-shaped depression, wherein the accommodation space is configured to accommodate a sampling tube and a reaction tube aligned with each other. The depression is configured to communicate with the accommodation space and exposed to one side of the base body, for the user to press the sampling tube. The moveable part moveably connects to the base body for ejecting the reaction tube from the base body.

In an embodiment, the moveable part has a sliding portion and a pressing portion connected with each other. The sliding portion is located in the accommodation space, and the pressing portion is located on the top of the base body. When the pressing portion is pressed by an external force, the sliding portion slides within the base body.

In an embodiment, the end of the sliding portion is configured to form a first opening and the sampling tube is aligned with the first opening and the reaction tube.

In an embodiment, the base body is configured to further form with a second opening. When the pressing portion is pressed by the external force, the end of the sliding portion ejects the reaction tube from the base body through the second opening.

In an embodiment, the moveable part is configured to form with a recess and a rib. The sampling tube is disposed in the recess and the rib is located at the bottom of the recess.

In an embodiment, the sliding direction of the moveable part is parallel to a central axis of the accommodation space.

In an embodiment, the biological sample pretreatment device further includes an elastic part connected to the pressing portion and the base body.

In an embodiment, the moveable part is configured to have a flat structure and one side surface of the base body is configured to form a guiding hole, in which the moveable part passes through the guiding hole and slides between an initial position and an extreme position relative to the base body.

In an embodiment, the moveable part is configured to form a through hole and a groove, the groove extends from the through hole to an edge of the moveable part, and a width of the groove is less than widths of the through hole and the reaction tube.

In an embodiment, the width of the through hole is greater than or equal to the width of the reaction tube. When the moveable part slides from the initial position to the extreme position relative to the base body, the through hole is aligned with the reaction tube.

In an embodiment, the sliding direction of the moveable part is perpendicular to a central axis of the accommodation space.

In an embodiment, the base body is configured to further include a first section and a second section pivotally connected to each other. The accommodation space extends from the first section to the second section.

In an embodiment, the reaction tube is a microtube, a molecular diagnostics tube, or a molecular diagnostic plastic capillary tube.

### BRIEF DESCRIPTION OF THE DRAWINGS

FIG. 1 shows an exploded view of a biological sample pretreatment device of an embodiment of the present invention.

FIG. 2 shows a perspective view of an assembled biological sample pretreatment device in FIG. 1.

FIG. 3 shows a perspective view of a moveable part shown in FIG. 2 that is pressed by an external force to slide, relative to the base body, along the Y-axis.

FIG. 4 shows a cross-sectional view taken along line A1-A2 in FIG. 2.

FIG. 5 shows a cross-sectional view taken along line A3-A4 in FIG. 3.

FIG. 6 shows an exploded view of a biological sample pretreatment device of another embodiment of the present invention.

FIG. 7 shows a perspective view of an assembled biological sample pretreatment device shown in FIG. 6.

FIG. 8 shows a perspective view of a moveable part shown in FIG. 7 that is pressed by an external force to slide, relative to the base body, along the X-axis.

FIG. 9 shows a schematic view of a bump on a moveable part located within a guiding groove in a backside of a base body.

FIG. 10 shows a schematic view of a bump on a moveable part slides along a guiding groove in a backside of a base body.

FIG. 11 shows a perspective view from another angle of the biological sample pretreatment device shown in FIG. 7.

FIG. 12 shows a perspective view from another angle of the biological sample pretreatment device shown in FIG. 8.

FIG. 13 shows a perspective view of a biological sample pretreatment device of yet another embodiment of the present invention.

FIG. 14 shows a perspective view from another angle of the biological sample pretreatment device shown in FIG. 13.

FIG. 15 shows a perspective view of the moveable part shown in FIG. 13 when pressed by an external force to slide, relative to base body 30, along the X-axis to an extreme position.

FIG. 16 shows a schematic view of the first section of the base body when rotating relative to the second section around a hinge.

### DETAILED DESCRIPTION

The following description illustrates a biological sample pretreatment device of embodiments of the present invention. However, it should be readily appreciated that the embodiments of the invention provide many suitable inventive concepts that can be implemented in a wide variety of specific backgrounds. The specific embodiments disclosed herein are merely for illustrating specific manners to use the present invention, and do not use to limit the scope of the present invention.

Unless defined otherwise, all terms used herein (including technical and scientific terms) have the same meaning as commonly understood by one of ordinary skill in the art to which this disclosure belongs. It should be appreciated that terms, for example, defined in a commonly used dictionary, should be interpreted as having a meaning that conforms to the relative skills of the disclosure and the background or the context of the disclosure, and should not be interpreted in an idealized or overly formal manner unless so defined.

The aforementioned and other technical contents, features and effects of the present invention will be clearly presented in the following detailed description of a preferred embodiment accompanying with the reference drawings. The directional terms described in the following embodiments, such as up, down, left, right, front or back, etc., are only directions referring to the accompanying drawings. Therefore, the directional terms used in the embodiments are used to illustrate but not to limit the present invention.

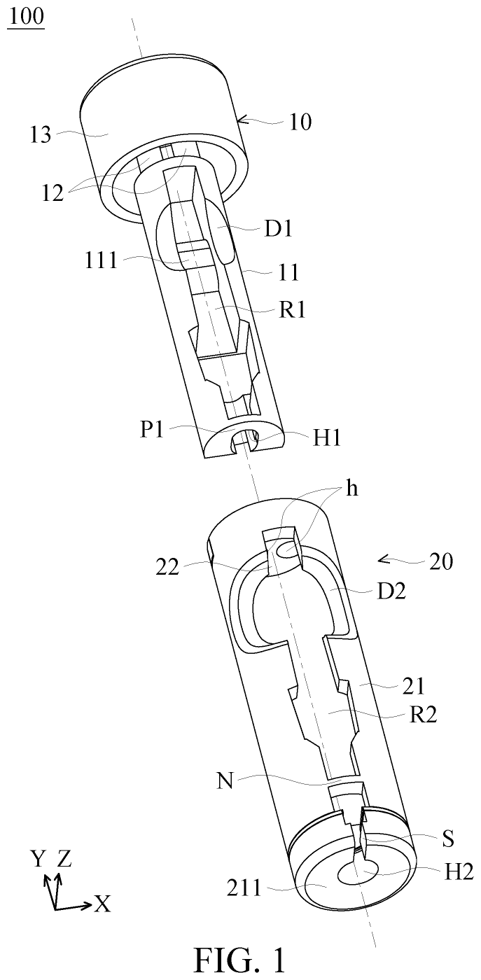

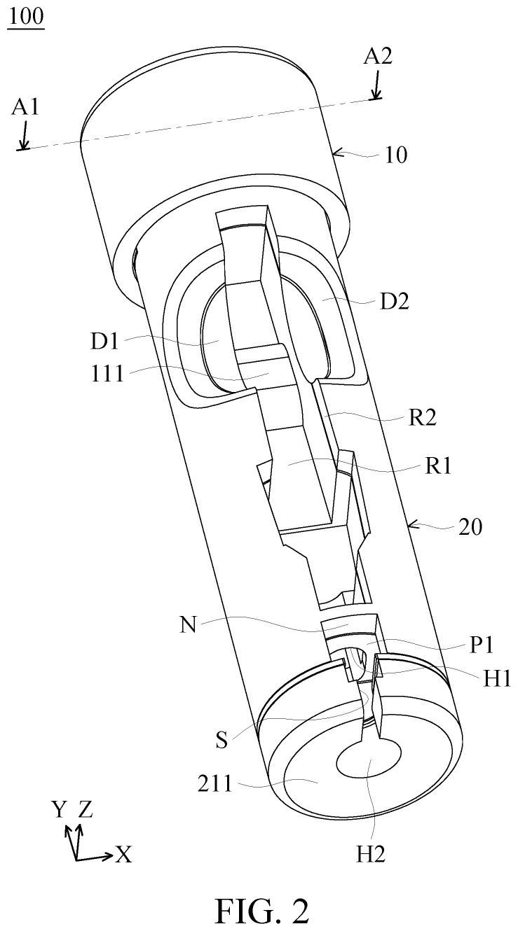

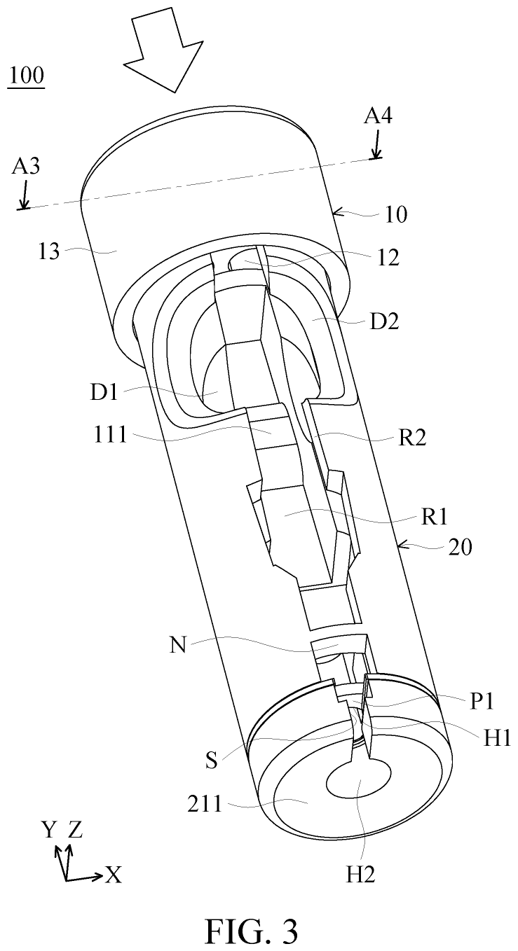

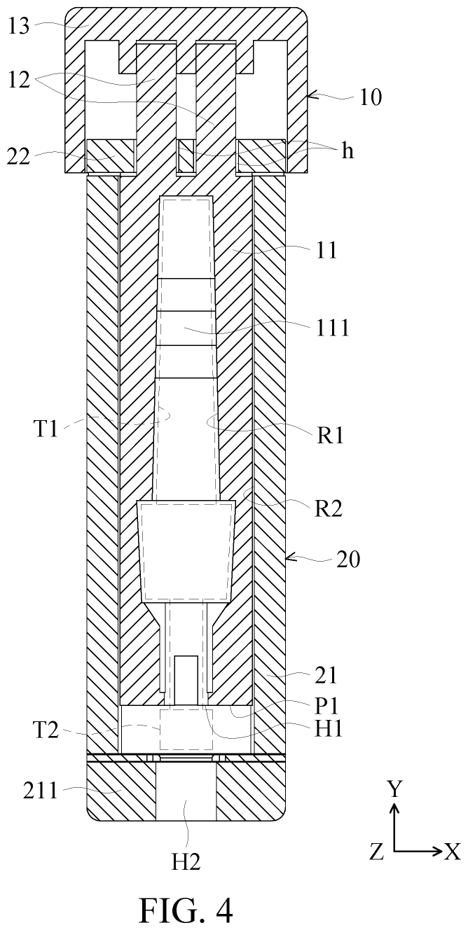

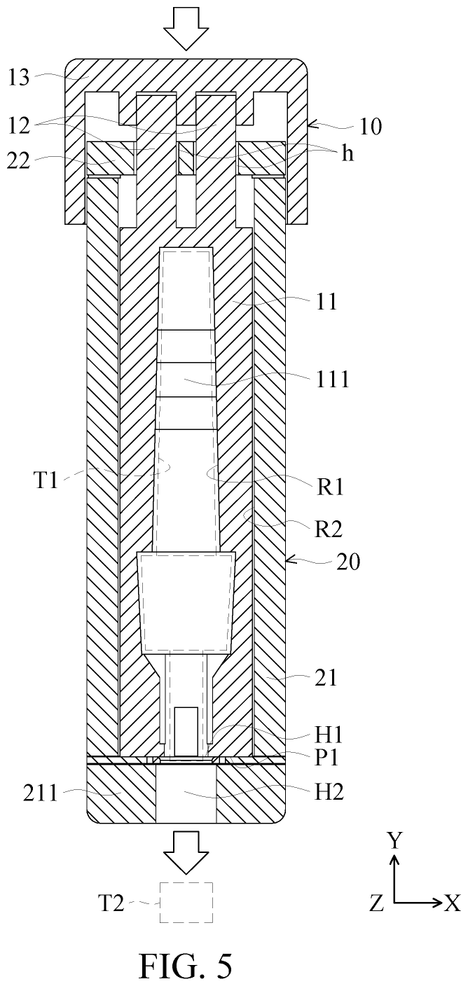

First, please refer to FIGS. 1, 2, 3, 4, and 5 together. FIG. 1 shows an exploded view of a biological sample pretreatment device 100 of an embodiment of the present invention. FIG. 2 shows a perspective view of the assembled biological sample pretreatment device 100 in FIG. 1. FIG. 3 shows a perspective view of a moveable part 10 shown in FIG. 2 that is pressed by an external force to slide, relative to the base body 20, along the Y-axis. FIG. 4 shows a cross-sectional view taken along line A1-A2 in FIG. 2. FIG. 5 shows a cross-sectional view taken along line A3-A4 in FIG. 3.

The biological sample pretreatment device 100 of an embodiment of the present invention may be applied to fields such as rapid antigen test, molecular diagnostics of PCR, or food inspection, but is not limited thereto. As shown in FIGS. 1, 2, 3, 4, and 5, the biological sample pretreatment device 100 of an embodiment of the present invention may include a movable part 10 and a base body 20. The movable part 10 is movably connected to the base body 20 and may slide relative to the base body 20.

For example, the movable part 10 and base body 20 may be formed of plastic or other polymer materials, but not limited to those disclosed in the embodiments of the present invention.

The movable part 10 may include a sliding portion 11, at least one neck part 12 and a pressing portion 13, wherein the neck part 12 is connected to the pressing portion 13. In detail, a recess R1, a curved depression D1 and a rib 111 formed on the sliding portion 11, wherein the recess R1 is configured to receive a sampling tube T1 (FIG. 4), and the depression D1 is exposed to one side of the moveable part 10. In addition, the rib 111 is formed at the bottom of the recess R1 and protrudes toward the depression D1.

On the other hand, the base body 20 may include a hollow member 21 and a lid 22 disposed on the top of the hollow member 21. The hollow member 21 forms an elongated accommodation space R2 for accommodating the movable part 10, and the accommodation space R2 is exposed to one side of the base body 20. During assembly, the neck part 12 of the movable part 10 can pass through the perforation h of the lid 22, and the pressing portion 13 is positioned on the top of the base body 20.

In an embodiment, when the pressing portion 13 of the movable part 10 is pressed by an external force, the sliding portion 11 of the movable part 10 may slide, relative to the base body 20, in the hollow member 21 along the Y-axis direction, so as to eject reaction tube T2 that is within the base body 20 (as the arrow shows in FIG. 5), wherein the sliding direction of the movable part 10 is parallel to the central axis (Z-axis direction) of the accommodation space R2.

In an embodiment, an elastic part (such as a spring) may be disposed between the pressing portion 13 and the lid 22 of the base body 20, so that the movable part 10 can automatically return to its initial position as shown in FIGS. 2 and 4.

It should be understood that a curved depression D2 is formed on the hollow member 21, and the shape and position thereof correspond to the depression D1 on the movable part 10, and it is exposed to one side of the base body 20. In this way, it may be convenient for the user to press the sampling tube T1 (FIG. 4) inside the recess R1 with his thumb, thereby greatly improving the convenience and comfort of use.

As shown in FIGS. 1, 2, 3, 4, and 5, a first opening H1 is formed at the end P1 of the sliding portion 11 of the movable part 10, and the sampling tube T1 disposed within the recess R1 is aligned with the first opening H1 and the reaction tube T2 within the hollow member 21 (FIG. 4). When the user wants to perform a rapid antigen test or molecular diagnostics of PCR, he can hold the base body 20 with his hand and use his thumb to directly press the sampling tube T1 along the Z-axis direction at the depressions D1 and D2 of the movable part 10 and the base body 20. In this way, samples can be easily squeezed from the sampling tube T1 into the reaction tube T2 through the first opening H1.

Specifically, this embodiment uses the depressions D1 and D2 formed on the movable part 10 and the base body 20 to not only effectively guide users to place their thumbs on the depressions D1 and D2, but also prevent users from dropping too much sample into the reaction tube T2 due to pressing too hard. On the other hand, the rib 111 formed on the bottom side of the recess R1 can also help to compress the sampling tube T1, so that the samples in the sampling tube T1 can be smoothly squeezed into the reaction tube T2.

After the samples in the sampling tube T1 are squeezed into the reaction tube T2, the user can press the pressing portion 13 on the top of the movable part 10 with his thumb along the Y-axis direction (as the arrows show in FIGS. 3 and 5). At this time, the sliding portion 11 of the movable part 10 can slide along the hollow member 21, so that the reaction tube T2 can be pushed out from the base body 20 by the end P1 of the sliding portion 11 through the second opening H2 at the bottom 211 of the hollow member 21 (FIG. 5).

The reaction tube T2 ejected from the base body 20 may be directly put into the equipment for reaction, so user will not directly touch the reaction tube T2 with his hand, thereby greatly reducing the risks of infection and contamination. The used movable part 10 and the base body 20 can be directly discarded, and may also be reused after proper treatment, which is not limited to those disclosed in the embodiments of the present invention.

For example, the reaction tube T2 may be a biological sample reaction tube, a microtube, a molecular diagnostics tube, or a molecular diagnostic plastic capillary tube, but not limited thereto.

As shown in FIGS. 1, 2, and 3, a slot S and a connecting arm N are formed on the hollow member 21 of the base body 20, wherein the slot S connects the second opening H2 at the bottom 211 of the hollow member 21 and the connecting arm N. Specifically, by forming the slot S and connecting arm N on the hollow member 21 of the base body 20, the flexibility of the bottom 211 of the hollow member 21 can be appropriately increased to eject the reaction tube T2 from the base body 20 through the second opening at the bottom 211 of the hollow member 21.

In an embodiment, based on the structure of the biological sample pretreatment device 100, when the user intends to perform rapid antigen test or molecular diagnostics of PCR, the sampling tube T1 and the reaction tube T2 can be loaded together into the biological sample pretreatment device 100 (as shown in FIG. 4), then the user can hold the base body 20 with his hand, and use his thumb to directly press the sampling tube T1 along the Z-axis direction at the depressions D1 and D2 of the movable part 10 and the base body 20. In this way, the samples can be easily squeezed from the sampling tube T1 into the reaction tube T2 through the first opening H1.

After squeezing the sample from the sampling tube T1 into the reaction tube T2, the user can press the pressing portion 13 on the top of the movable part 10 with the thumb along the Y-axis direction (as the arrows show in FIGS. 3 and 5). At this time, the sliding portion 11 of the movable part 10 may slide along the hollow member 21, so that the reaction tube T2 may be ejected, by the end P1 of the sliding portion 11, from the base body 20 through the second opening H2 at the bottom 211 of the hollow member 21 (FIG. 5).

Since the reaction tube T2 ejected from the base body 20 may be directly put into the equipment to be reacted, the user will not directly touch the reaction tube T2 with his hands, thereby greatly reducing the risks of infection and contamination.

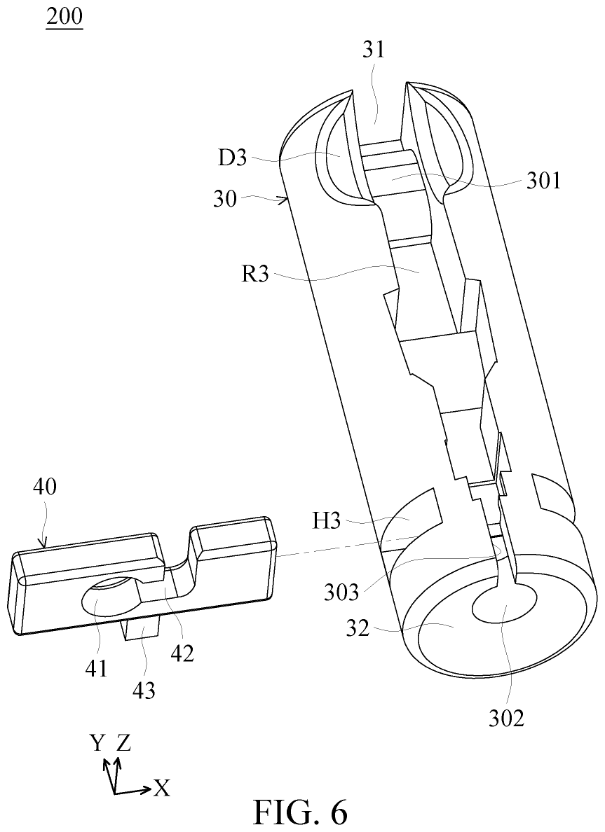

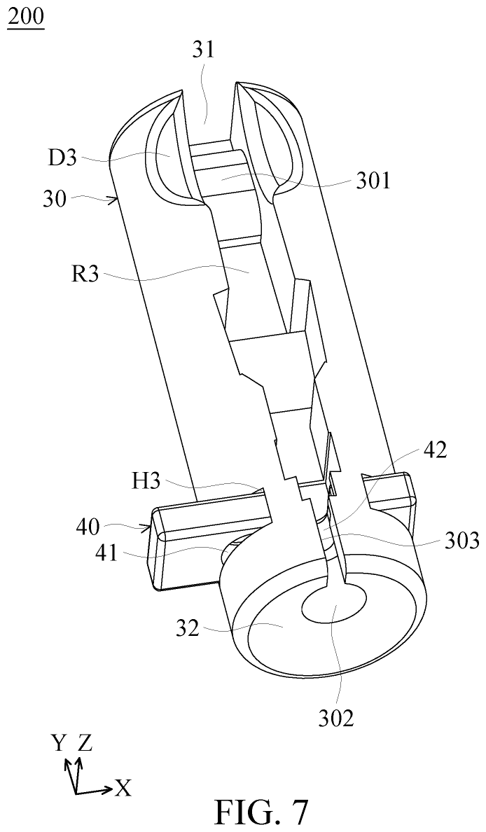

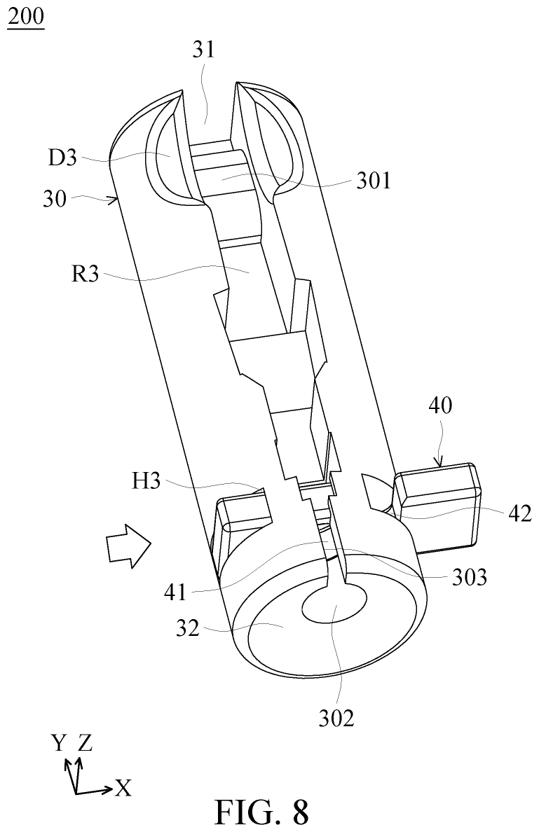

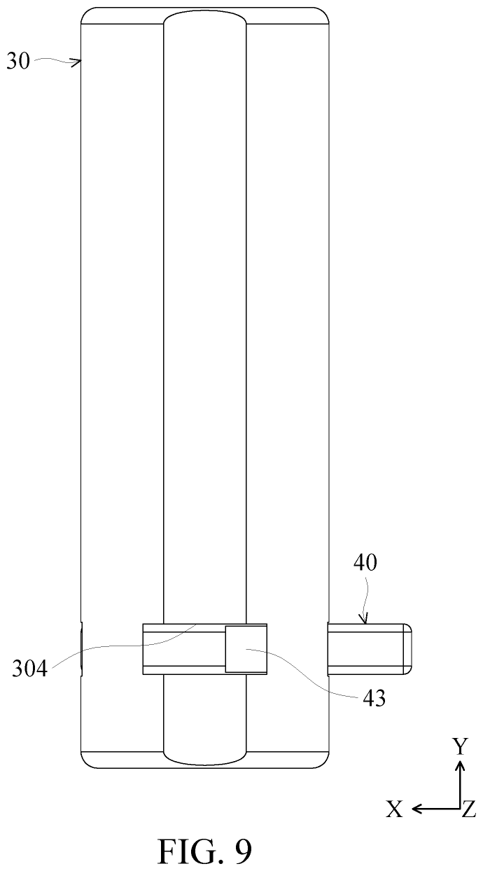

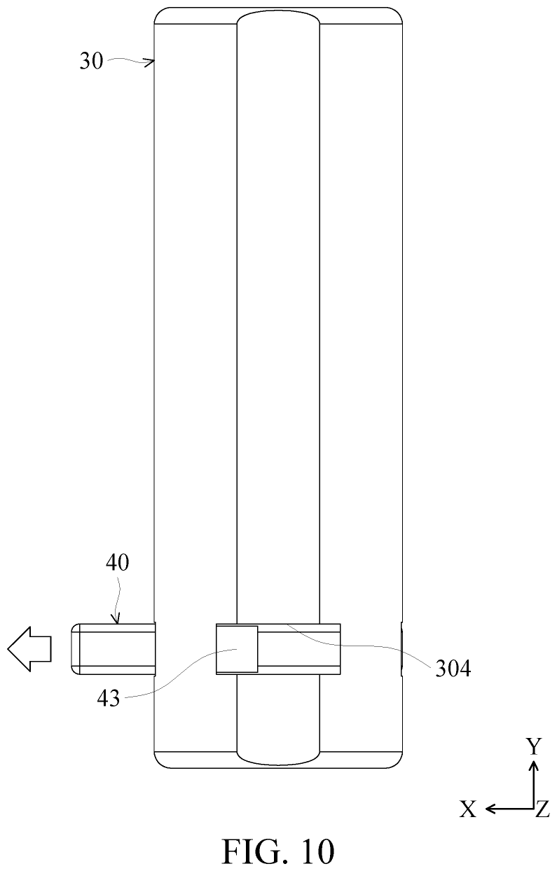

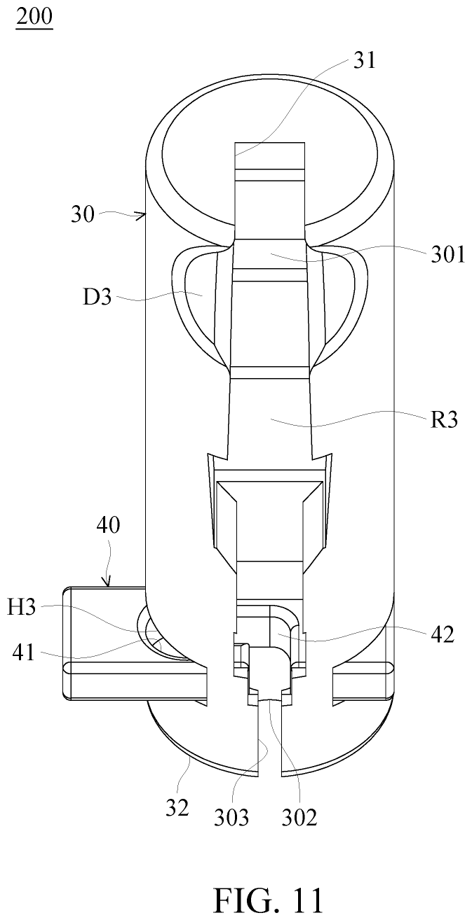

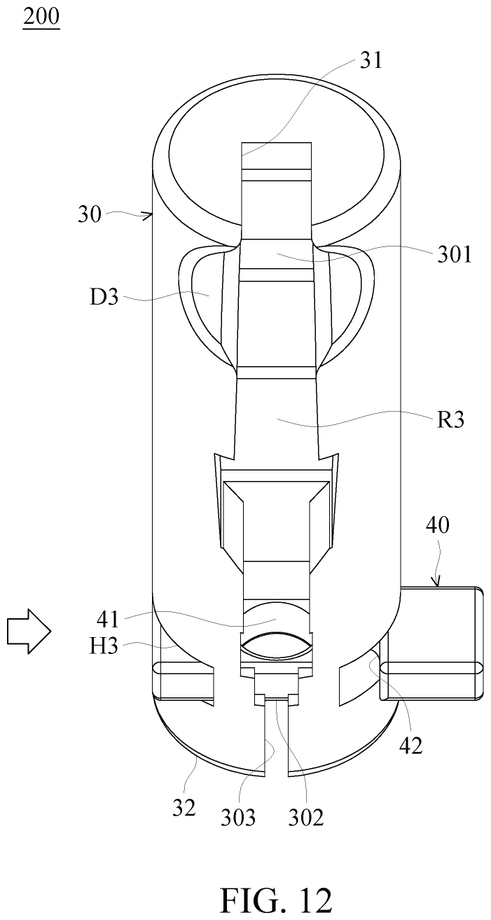

Then, please refer to FIGS. 6, 7, 8, 9, 10, 11, and 12 together. FIG. 6 shows an exploded view of biological sample pretreatment device 200 in accordance with another embodiment of the present invention. FIG. 7 shows a perspective view of the assembled biological sample pretreatment device 200 shown in FIG. 6. FIG. 8 shows a perspective view of the moveable part 40 shown in FIG. 7 that is pressed by an external force to slide, relative to the base body 30, along the X-axis to an extreme position. FIG. 9 shows a schematic view of the bump 43 on the moveable part 40 located within the guiding groove 304 in a backside of the base body 30. FIG. 10 shows a schematic view of the bump 43 on the moveable part 40 slides along the guiding groove 304 in a backside of the base body 30. FIG. 11 shows a perspective view from another angle of the biological sample pretreatment device 200 shown in FIG. 7. FIG. 12 shows a perspective view from another angle of the biological sample pretreatment device 200 shown in FIG. 8.

The biological sample pretreatment device 200 of another embodiment of the present invention may also be applied to the fields, such as rapid antigen test, molecular diagnostics of PCR, or food inspection, but is not limited thereto. As shown in FIGS. 6, 7, 8, 9, 10, 11, and 12, the biological sample pretreatment device 200 of another embodiment of the present invention may include a base body 30 and a movable part 40. The movable part 40 is movably connected to the base body 30 and can slide, relative to the base body 30, along the X-axis direction. That is, the sliding direction of the movable part 40 is perpendicular to the central axis of the accommodation space R3.

Specifically, the base body 30 forms an elongated accommodation space R3, an opening 31, a depression D3, an hole 302, a slot 303, a guiding groove 304 and a guiding hole H3, wherein the accommodation space R3 is used to accommodate the sampling tube and the reaction tube (not shown) aligned with each other. The accommodation space R3 is connected to the opening 31, the depression D3, the hole 302, the slot 303, the guiding groove 304 and the guiding hole H3, wherein the hole 302 is located at the bottom 32 of the base body 30.

Besides, the rib 301 is formed on the bottom side of the accommodation space R3 and protrudes toward the direction of the depression D3. When the user presses the sampling tube within the accommodation space R3 with his thumb, the depression D3 may provide a reaction force to press on the sampling tube, so that the sample in the sampling tube can be squeezed smoothly into the reaction tube.

In this embodiment, the moveable part 40 has a flat structure and passes through the guiding hole H3 on the base body 30 in a slideable manner, wherein the guiding hole H3 is located on a side surface of the base body 30. Specifically, the movable part 40 may form with a through hole 41, a groove 42 and a bump 43, wherein the groove 42 extends from the through hole 41 to an edge of the movable part 40, and the width of the groove 42 is less than the widths of the through hole 41 and the reaction tube. Besides, the bump 43 may be formed on the backside of the movable part 40.

In actual use, the sampling tube and the reaction tube (not shown) aligned with each other may be pre-loaded in the accommodation space R3 of the base body 30, and the moveable part 40 may pass through the guiding hole H3, relative to the base body 30 at an initial position (as shown in FIGS. 7, 9, and 11). At this time, the bump 43 on the backside of the movable part 40 is located at a first location in the guiding groove 304 of the base body 30 (FIG. 9).

As shown in FIGS. 6, 7, and 11, since the width of the groove 42 is less than the widths of the through hole 41 and the reaction tube (not shown), the reaction tube is blocked by the moveable part 40 located within the accommodation space R3. Therefore, and the reaction tube cannot be ejected from the hole 302 at the bottom 32 of the base body 30.

In this state, the user may use the thumb to press the sampling tube located within the accommodation space R3, and squeeze the sample in the sampling tube into the reaction tube. Then, an external force can be applied to push the movable part 40 along the X-axis direction, and the movable part 40 can slide to an extreme position relative to the base body 30 along the X-axis direction (as shown in FIGS. 8, 10, and 12). At this time, the bump 43 on the backside of the moveable part 40 may slide from the first location (FIG. 9) to the second location (FIG. 10) along the guiding groove 304 of the base body 30.

When the movable part 40 slides to the extreme position relative to the base body 30 along the X-axis direction, the through hole 41 with a larger size on the movable part 40 is aligned with the accommodation space R3, the opening 302 and the reaction tube. At this time, the user can manually squeeze the base body 30 laterally, so that the base body 30 can be used to press the reaction tube to pass through the through hole 41 on the movable part 40 and be ejected from the base body 30 through the hole 302 at the bottom 32 of the base body 30. In this embodiment, the width of the through hole 41 is greater than or equal to the width of the reaction tube.

It should be appreciated that, by forming the slot 303 on the base body 30, this embodiment can appropriately increase the flexibility of the bottom 32 of the base body 30 and help the reaction tube to be ejected from the hole 302 at the bottom 32 of the base body 30, thereby greatly improving the convenience and comfort of use.

In an embodiment, based on the structure of the biological sample pretreatment device 200, when the user wants to perform a rapid antigen test or a molecular diagnostics of PCR, the sampling tube T1 and the reaction tube T2 may be loaded together into the base body 30 of the biological sample pretreatment device 200. Then, the user can hold the base body 30 with his hand, and use his thumb to press the sampling tube located within the accommodation space R3, thereby squeezing the sample in the sampling tube into the reaction tube.

Then, an external force may be applied along the X-axis direction to push the movable part 40, thus impelling the movable part 40 to slide to an extreme position relative to the base body 30 along the X-axis direction (as shown in FIGS. 8, 10, and 12). Since the through hole 41 with larger size on the movable part 40 is aligned with the accommodation space R3, the opening 302 and the reaction tube, the user can squeeze the base body 30 laterally by hand, so that the base body 30 can be used to press the reaction tube through the through hole 41 on the movable part 40, and eject the reaction tube from the base body 30 through the hole 302 at the bottom 32 of the base body 30.

Since the reaction tube, after ejected from the base body 30, can be directly placed into the equipment to be reacted, the user will not directly touch the reaction tube with his hands, thereby greatly reducing the risks of infection and contamination.

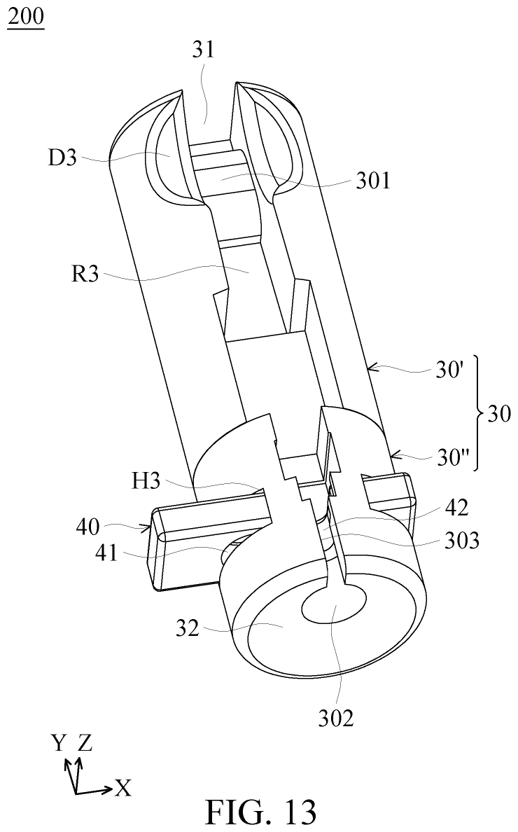

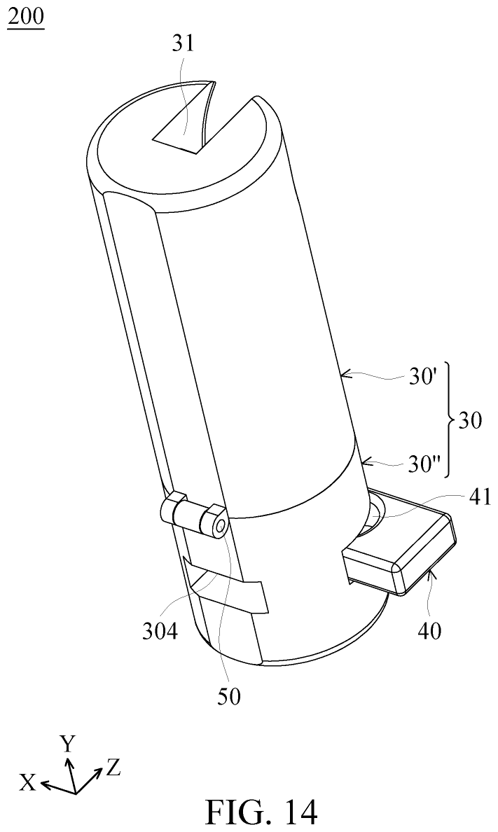

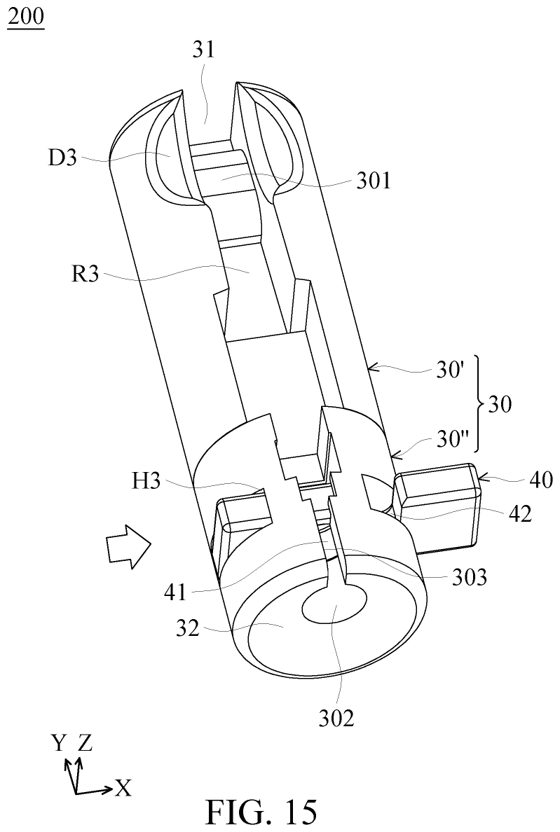

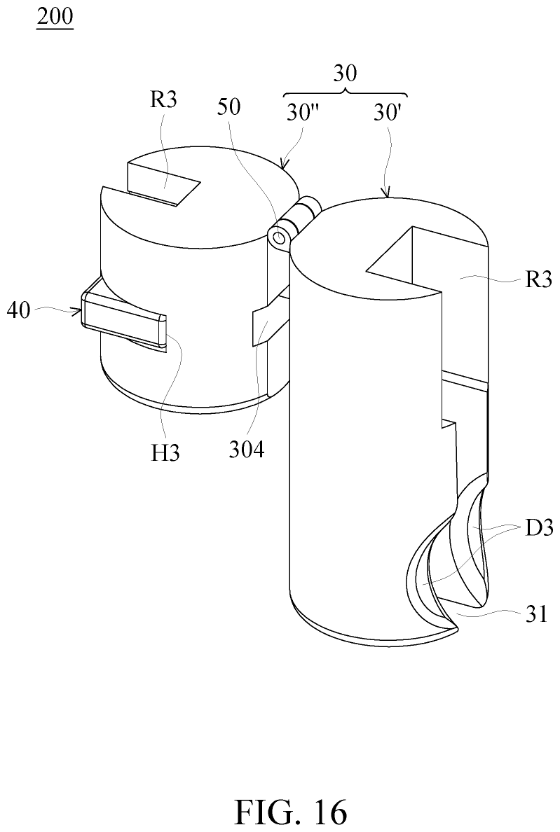

Please refer to the FIGS. 13, 14, 15, 16 together. FIG. 13 shows a perspective view of a biological sample pretreatment device 200 of another embodiment of the present invention. FIG. 14 shows a perspective view from another angle of the biological sample pretreatment device 200 shown in FIG. 13. FIG. 15 shows a perspective view of the moveable part 40 shown in FIG. 13 when pressed by an external force to slide, relative to base body 30, along the X-axis to an extreme position. FIG. 16 shows a schematic view of the first section 30′ of the base body 30 when rotating relative to the second section 30″ around the hinge 50.

Referring to FIGS. 13, 14, 15, 16, the main difference between this embodiment and the biological sample pretreatment device 200 shown in FIGS. 6 to 12 is that the base body 30 includes a first section 30′ and a second section 30″ that can rotate with each other, wherein the first section 30′ and the second section 30″ are connected to each other through a hinge 50, and the accommodation space R3 is extended from the first section 30′ to the second section 30″.

As shown in FIG. 16, since the first section 30′ and the second section 30″ of the base body 30 is pivotally connected to each other through the hinge 50, the first section 30′ can rotate relative to the second section 30″ around the hinge 50. Thus, it is convenient for the operator to place or take out the sampling tube or the reaction tube in the accommodation space R3, thereby greatly improving the convenience of use.

### EXPERIMENTS

Following descriptions are the implementation processes of nucleic acid sample pretreatment using the traditional manual operation method and the biological sample pretreatment device.

### Traditional Manual Operation:

(1) Specimen Preparation: After appropriately deactivating the standard virus strain of SARS-CoV-2 (Severe acute respiratory syndrome coronavirus 2), SARS-CoV-2 (National Standard) (Strain: CGMH-CGU-01/20203; Source: Chang-Gung Memorial Hospital) provided by Taiwan Food and Drug Administration (TFDA) of the Ministry of Health and Welfare, the deactivated virus strain was formulated into a 20 copies/μl test sample, and then prepared in human nasopharyngeal specimen (negative) as a simulated specimen.

(2) Hold the sampling swab to dip the simulated sample by one hand, whereas insert the sampling swab into the sampling tube by the other hand. Since there was a virus nucleic acid reagent (Triton X-100) for rapid extraction in the sampling tube, a virus nucleic extraction can be completed upon standing for one minute.

(3) Then, lock the opening of the sampling tube with a tube cap containing a liquid outlet.

(4) Invert the sampling tube and squeeze the sampling tube with fingers, so that the sample in the tube can drop into the reaction tube held by the other hand.

(5) Then, hold the reaction tube by hand and put it into the reaction chamber of the real-time PCR detection equipment to carry out the qRT-PCR detection reaction.

### Using Biological Sample Pretreatment Device:

(1) Specimen Preparation: After appropriately deactivating the standard virus strain of SARS-CoV-2 (Severe acute respiratory syndrome coronavirus 2), same as the aforementioned virus strain, (National Standard) (Strain: CGMH-CGU-01/20203; Source: Chang-Gung Memorial Hospital) provided by Taiwan Food and Drug Administration (TFDA) of the Ministry of Health and Welfare, the deactivated virus strain was formulated into a 20 copies/μl test sample, and then prepared in human nasopharyngeal specimen (negative) as a simulated specimen.

(2) Hold the sampling swab to dip the simulated sample by one hand, whereas insert the sampling swab into the sampling tube by the other hand. Since there was a virus nucleic acid reagent (Triton X-100) for rapid extraction in the sampling tube, a virus nucleic extraction can be completed upon standing for one minute.

(3) Then, lock the opening of the sampling tube with a tube cap containing a liquid outlet.

(4) Load the sampling tube and the reaction tube into the biological sample pretreatment device together. In this experiment, the biological sample pretreatment device 100 in the abovementioned embodiment is adopted.

(5) Hold the biological sample pretreatment device and squeeze the sampling tube with hand to drop the sample into the reaction tube. Then, use an elastic ejecting structure or a release structure to let the reaction tube discharge from the biological sample pretreatment device, and directly put it into the reaction hole of the real-time PCR detection equipment to carry out the qRT-PCR detection reaction without using hand.

qRT-PCR Detection and Result Comparison

The primer sets and probes used for conducting qRT-PCR reaction are those announced by the Centers for Disease Control and Prevention (CDC) of the United States, which include 2 groups, respectively designed for the N1 and N2 genes (nucleocapsid gene) of the SARS-CoV-2 virus. The sequences of the primer sets and probes are shown in Table 1.

TABLE 1
primer sets and probes used for
detecting the N1 and N2 genes of
the SARS-CoV-2 virus

| | Sequence |
|---|---|
| Name | (5′ → 3') |
| 2019-nCoV_N1 forward | GACCCCAAAA |
| primer | TCAGCGAAAT |
| 2019-nCoV_N1 reverse | TCTGGTTACT |
| primer | GCCAGTTGAA |
| | TCTG |
| 2019-nCoV_N1 probe | ACCCCGCATT |
| | ACGTTTGGTG |
| | GACC |
| 2019-nCoV_N2 forward | TTACAAACAT |
| primer | TGGCCGCAAA |
| 2019-nCoV_N2 reverse | GCGCGACATT |
| primer | CCGAAGAA |
| 2019-nCoV_N2 probe | ACAATTTGCC |
| | CCCAGCGCTT |
| | CAG |

The reagent used for conducting qRT-PCR reaction is KAPA PROBE FAST Universal One-Step qRT-PCR Master Mix, and the formulation of the reagent is shown in Table 2. iPMx Molecular Rapid Test System is used as detection equipment. The detection result is shown in Table 3.

TABLE 2
reagent formulation used for detecting the nucleocapsid
genes (N1, N2) genes of the SARS-CoV-2 virus.

| Reagent Component | Used Volume (μL) |
|---|---|
| 2X Master Mix | 25 |
| 50X RT Mix | 1 |
| RNase-free water | 11.5 |
| 20X FRP(N1 \grave{ } N2) | 2.5 |
| Sample | 10 |
| Total Volume | 50 |

Note:
FRP represents a mixture of forward primer, reverse primer, and probe.

TABLE 3
The detection results of the above two pretreatment methods

Detection Limit Test
20 copies/μl (deactivated
SARS-CoV-2 standard sample)

| Detected Target | N1 | N2 |
|---|---|---|
| Traditional Manual | +(3/3, 100%) | +(3/3, 100%) |
| Operation | | |
| Using Biological Sample | +(3/3, 100%) | +(3/3, 100%) |
| Pretreatment Device | | |

According to the comparison of the above detection results, it may be appreciated that the effect of nucleic acid sample pretreatment using the biological sample pretreatment device of the present invention should be equivalent to that of traditional manual operation. It should be noted that, since the biological sample pretreatment device of the present invention can directly remove the reaction tube from the device and directly put it into the reaction chamber of the detection device, the user will not directly touch the reaction tube with his hands, thereby greatly reducing the risks of infection and contamination.

Although the embodiments of the present invention and advantages thereof have been disclosed above, it should be appreciated that those skilled in the art can make changes, substitutions and modifications without departing from the spirit and scope of the present invention. In addition, the protection scope of the present invention is not limited to the process, machine, manufacture, material composition, device, method and steps in the specific embodiments described in the description, and any person with ordinary knowledge in the technical field can learn from the disclosure of the present invention. It should be appreciated that the current or future developed processes, machines, manufactures, material compositions, devices, methods and steps can be used in accordance with the present invention as long as they can perform substantially the same functions or obtain substantially the same results in the embodiments described herein. Therefore, the protection scope of the present invention includes the abovementioned process, machine, manufacture, material compositions, device, method and steps. In addition, each claim may constitute an individual embodiment, and the protection scope of the present invention also includes the combination of each claim and embodiments.

While the invention has been described above by preferred embodiments, but the invention is not limited thereto. Any person who is familiar with the art can make some changes and modifications without departing from the spirit and scope of the present invention. Therefore, the scope of protection of the present invention should be as defined by the appended claims.

What is claimed is:

1. A biological sample pretreatment device, comprising:
a base body, formed with an elongated accommodation space and an arc-shaped depression, wherein the accommodation space is configured to accommodate a sampling tube and a reaction tube aligned with each other, and the depression is configured to communicate with the accommodation space and exposed to one side of the base body for an user to press the sampling tube; and
a moveable part, moveably connected to the base body for ejecting the reaction tube from the base body.

2. The biological sample pretreatment device as claimed in claim 1, wherein the moveable part has a sliding portion and a pressing portion connected with each other, the sliding portion is located in the accommodation space, the pressing portion is located on a top of the base body, and when the pressing portion is pressed by an external force, the sliding portion slides within the base body.

3. The biological sample pretreatment device as claimed in claim 2, wherein an end of the sliding portion is configured to form a first opening, and the sampling tube is aligned with the first opening and the reaction tube.

4. The biological sample pretreatment device as claimed in claim 3, wherein the base body is configured to further form with a second opening, and, when the pressing portion is pressed by the external force, the end of the sliding portion ejects the reaction tube out of the base body through the second opening.

5. The biological sample pretreatment device as claimed in claim 2, wherein the moveable part is configured to form with a recess and a rib, the sampling tube is disposed in the recess and the rib is located at the bottom of the recess.

6. The biological sample pretreatment device as claimed in claim 2, wherein the moveable part slides in a direction that is parallel to a central axis of the accommodation space.

7. The biological sample pretreatment device as claimed in claim 2, further comprising an elastic part connected to the pressing portion and the base body.

8. The biological sample pretreatment device as claimed in claim 1, wherein the moveable part is configured to have a flat structure, and one side surface of the base body is configured to form a guiding hole, wherein the moveable part passes through the guiding hole and slides between an initial position and an extreme position relative to the base body.

9. The biological sample pretreatment device as claimed in claim 8, wherein the moveable part is configured to form a through hole and a groove, the groove extends from the through hole to an edge of the moveable part, and the width of the groove is less than the widths of the through hole and the reaction tube.

10. The biological sample pretreatment device as claimed in claim 9, wherein the width of the through hole is greater than or equal to the width of the reaction tube, and when the moveable part slides from the initial position to the extreme position relative to the base body, the through hole is aligned with the reaction tube.

11. The biological sample pretreatment device as claimed in claim 8, wherein the moveable part slides in a direction that is perpendicular to a central axis of the accommodation space.

12. The biological sample pretreatment device as claimed in claim 8, wherein the base body is configured to further comprise a first section and a second section pivotally connected to each other, and the accommodation space extends from the first section to the second section.

13. The biological sample pretreatment device as claimed in claim 1, wherein the reaction tube is a microtube, a molecular diagnostics tube, or a molecular diagnostic plastic capillary tube.
